(19) United States
(12) Patent Application Publication
(10) Pub. No.: US 2017/0109253 A1
(43) Pub. Date: Apr. 20, 2017

(54) SYSTEM AND METHOD FOR FILTERING SYSTEM LOG UNDER OPERATING SYSTEM

(71) Applicant: INSYDE SOFTWARE CORP., TAIPEI (TW)

(72) Inventor: Chih-Chieh SHEN, TAIPEI (TW)

(73) Assignee: INSYDE SOFTWARE CORP., TAIPEI (TW)

(21) Appl. No.: 15/294,579

(22) Filed: Oct. 14, 2016

(30) Foreign Application Priority Data
Oct. 20, 2015 (TW) 104134360

(51) Int. Cl. G06F 11/36

(52) U.S. Cl. CPC G06F 11/364; G06F 11/3692

(57) ABSTRACT

The present invention is a system and a method for filtering a system log under an operating system, implemented on an electronic device installed with the operating system. The electronic device executes a system log filter procedure including a program compile-time stage and a program runtime stage. The program compile-time stage is executed to establish an editable database storing debugging information. The program runtime stage is executed to configure configured filtered information, and outputs a filtered system log according to the debugging information corresponding to the configured filtered information. The electronic device connects to a remote device to configure and receive new configured filtered information, and the program runtime stage is executed to filter system log corresponding to the new configured filtered information. Therefore, the efficiency of tracing a specific system log is raised.

### CROSS-REFERENCE TO RELATED APPLICATIONS

This application claims the priority benefit of TW application serial No. 104134360, filed on Oct. 20, 2015. The entirety of the above-mentioned patent applications is hereby incorporated by reference herein and made a part of the specification.

### BACKGROUND OF THE INVENTION

1. Field of the Invention

The present invention relates a method for outputting a system log under an operating system, and more particularly to a system and a method for filtering a system log under an operating system.

2. Description of the Related Art

Technological products are developed quickly. Besides personal computers and notebook computers, electronic devices, such as smart phones or tablet computers, are widely applied in daily use. Since these electronic devices are hardware, the electronic devices need to be installed with software to meet needs of users. For example, the electronic device is installed with an operating system (OS). The operating system is a program between the hardware and the software, and the operating system may allocate system resources, provide environment to execute the software, and provide a user interface. For example, the operating system may be Windows™, Mac™ OS, Linux™, or Unix-Like.

The operating system has a procedure to record multiple system logs, such as logfiles of the operating system. For example, the procedure may be Syslog. The Syslog may transmit the system logs in an internet protocol, and a user may analyze the operating system according to the system logs. Then, the user may realize that when, where, how, and what acts of a file is executed. In other words, the system logs may record information when the operating system works, and such information may include what procedure operates the operating system and what event happens. A program designer may acquire the system logs to analyze, further troubleshoot the operating system and Internet service, and record login information.

The Syslog records the system logs according to a “message level” set by the program designer, but the system logs corresponding to the message level are disorganized. Then, the program designer may inconveniently analyze and debug the system logs. Further, the system logs are too many to recognize useful information, and debugging difficulties are increased. When a processor of the electronic device is overloaded, the processer may not efficiently execute the Syslog, and the system logs may not be immediately recorded. Then, the program designer may not immediately find out the problems of the operating system. Therefore, the technique of recording a system log needs to be improved.

### SUMMARY OF THE INVENTION

An objective of the present invention is to provide a system and a method for filtering a system log under an operating system. A program designer may set conditions to filter out a specific system log when program runtime stage of the operating system is executed, and may change the conditions to filter out another system log when program runtime stage is executed. Then, the program designer may efficiently analyze the operating system according to the filtered system log.

To achieve the foregoing objective, the method for filtering a system log under an operating system is implemented on an electronic device installed with the operating system, and the electronic device executes a system log filter procedure. The method comprises the steps of:

executing a program compile-time stage to establish an editable database; wherein the editable database stores debugging information;

executing a program runtime stage, receiving configured filtered information, and executing a system record procedure of the operating system to output a filtered system log according to the debugging information stored in the editable database and corresponding to the configured filtered information.

The electronic device is installed with the operating system, and may be used by a user. The electronic device may execute the system log filter procedure, and the system log filter procedure may execute the program compile-time stage and the program runtime stage. Further, the system log filter procedure may receive the configured filtered information, and then may output the filtered system log recorded by the system record procedure of the operating system. Therefore, efficiency of tracing a specific system log may be raised.

Besides, to achieve the foregoing objective, the system for filtering the system log under the operating system comprises an electronic device installed with the operating system, and the electronic device comprises:

an input unit, configured to receive information inputted by a user;

an output unit;

a transmitting unit, configured to receive information inputted by a remote user;

a memory unit; and

a central processing unit, configured to be electronically connected to the input unit, the output unit, the transmitting unit, and the memory unit;

wherein the central processing unit executes a system log filter procedure according to command information input by the user;

wherein the system log filter procedure comprises a program compile-time stage and a program runtime stage;

wherein the system log filter procedure executes the program compile-time stage to store debugging information edited by the user in the memory unit;

wherein when the system log filter procedure executes the program runtime stage, the system log filter procedure receives configured filtered information;

wherein the central processing unit executes a system record procedure to output a filtered system log of the operating system according to the debugging information stored in the memory unit and corresponding to the configured filtered information, and the output unit outputs the filtered system log.

The electronic device receives information input by the user using the input unit, or receives remote information input by the user using the transmitting unit. The central processing unit executes the system log filter procedure according to the command information input by the user. The system log filter procedure executes the program compile-time stage to store debugging information edited by the user in the memory unit. When the system log filter procedure executes the program runtime stage, the system log filter procedure receives the configured filtered information. Then, the central processing unit executes the system record procedure to output a filtered system log of the operating system according to the debugging information stored in the memory unit and corresponding to the configured filtered information, and the output unit outputs the filtered system log.

Further, the central processing unit receives new configured filtered information remotely configured by the user through the transmitting unit. Then, the central processing unit outputs another filtered system log of the operating system according to the debugging information stored in the memory unit and corresponding to the new configured filtered information. Therefore, the user may recognize and analyze the filtered system log, and the efficiency of tracing a specific system log may be raised.

Other objectives, advantages and novel features of the invention will become more apparent from the following detailed description when taken in conjunction with the accompanying drawings.

### BRIEF DESCRIPTION OF THE DRAWINGS

FIG. 1 is system framework diagram of an embodiment of the present invention;

FIG. 2 is block diagram of an electronic device of an embodiment of the present invention;

FIG. 3 is a framework diagram of a system log filter procedure of an embodiment of the present invention;

FIG. 4A is a schematic diagram of a system log of an embodiment of the present invention;

FIG. 4B is a schematic diagram of another system log of an embodiment of the present invention;

FIG. 4C is a schematic diagram of still another system log of an embodiment of the present invention;

FIG. 5 is a flowchart of an embodiment of the present invention.

### DETAILED DESCRIPTION OF THE INVENTION

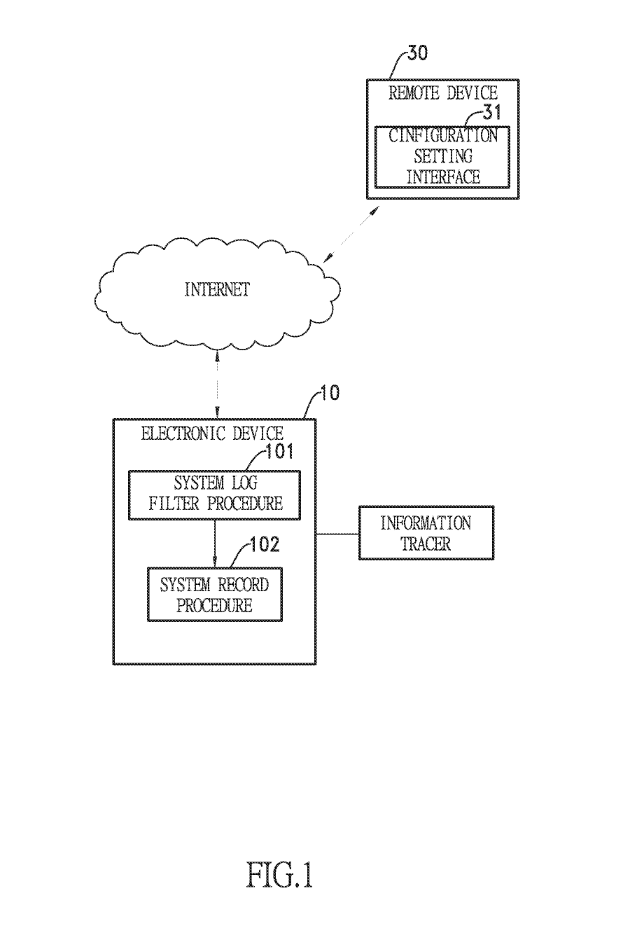

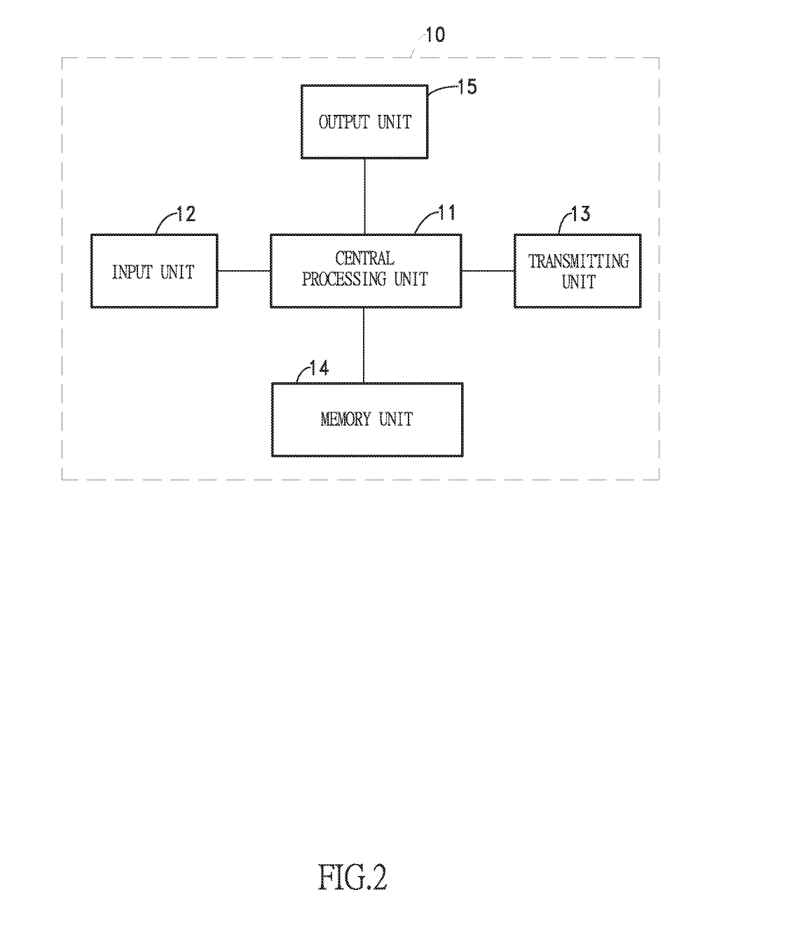

With reference to FIGS. 1 and 2, the present invention is a system and a method for filtering a system log under an operating system. The system for filtering the system log under the operating system comprises an electronic device 10 and a remote device 30.

The electronic device 10 may be a computer or a mobile device, and the remote device 30 may be a computer or a mobile device. The electronic device 10 may be directly connected to the Internet through a wired or wireless connection, and may transmit information through the Internet. The remote device 30 may exchange information with the electronic device 10 through the Internet.

The electronic device 10 and the remote device 30 are respectively installed with an operating system. The operating system may be Windows™, Mac™ OS, Linux™, or Unix-Like.

The electronic device 10 comprises a central processing unit 11, an input unit 12, a transmitting unit 13, a memory unit 14, and an output unit 15.

The central processing unit 11 is electronically connected to the input unit 12, the transmitting unit 13, the memory unit 14, and the output unit 15. The central processing unit 11 installs the operating system on the electronic device 10. The memory unit 14 stores a system log filter procedure 101, and the operating system comprises a system record procedure 102, such as the Syslog. The memory unit 14 may store a system log produced by the system record procedure 102.

The input unit 12 receives information inputted by a user, such as an information tracer. The transmitting unit 13 is connected to the Internet through an internet protocol, and receives information input by the user using the remote device 30. The central processing unit 11 receives information of the input unit 12 and the transmitting unit 13, and executes the system log filter procedure 101 according to command information input by the user.

The system log filter procedure 101 comprises a program compile-time stage and a program runtime stage. The system log filter procedure 101 executes the program compile-time stage to store debugging information edited by the user in the memory unit 14. When the system log filter procedure 101 executes program runtime stage, the system log filter procedure 101 receives configured filtered information configured by the user. In the embodiment, the configured filtered information may comprise a letter, a symbol, a string, a character, or the combination thereof.

The central processing unit 11 executes the system record procedure 102 of the operating system to output a filtered system log according to the debugging information stored in the memory unit 14 and corresponding to the configured filtered information, and the output unit 15 outputs the filtered system log.

In the embodiment, the remote device 30 comprises a configuration setting interface 31, and the user may operate the configuration setting interface 31 to input information. The configuration setting interface 31 may comprise a webpage configuration page and a command information bar. The user may use the webpage configuration page to produce new configured filtered information, and may use the command information bar to input new command information.

Further, the user may use the remote device 30 to transmit the new configured filtered information and the new command information to the transmitting unit 13 of the electronic device 10 through the Internet. The central processing unit 11 of the electronic device 10 receives the new configured filtered information and the new command information remotely configured by the user.

When the central processing unit 11 executes the system log filter procedure 101 to use the new configured filtered information and executes the system record procedure 102 to output another filtered system log of the operating system according to the debugging information stored in the memory unit 14 and corresponding to the new configured filtered information, the user may recognize and analyze the filtered system log. Besides, the system log filter procedure 101 may not execute the program compile-time stage on the electronic device 10, and may execute the program compile-time stage on another device.

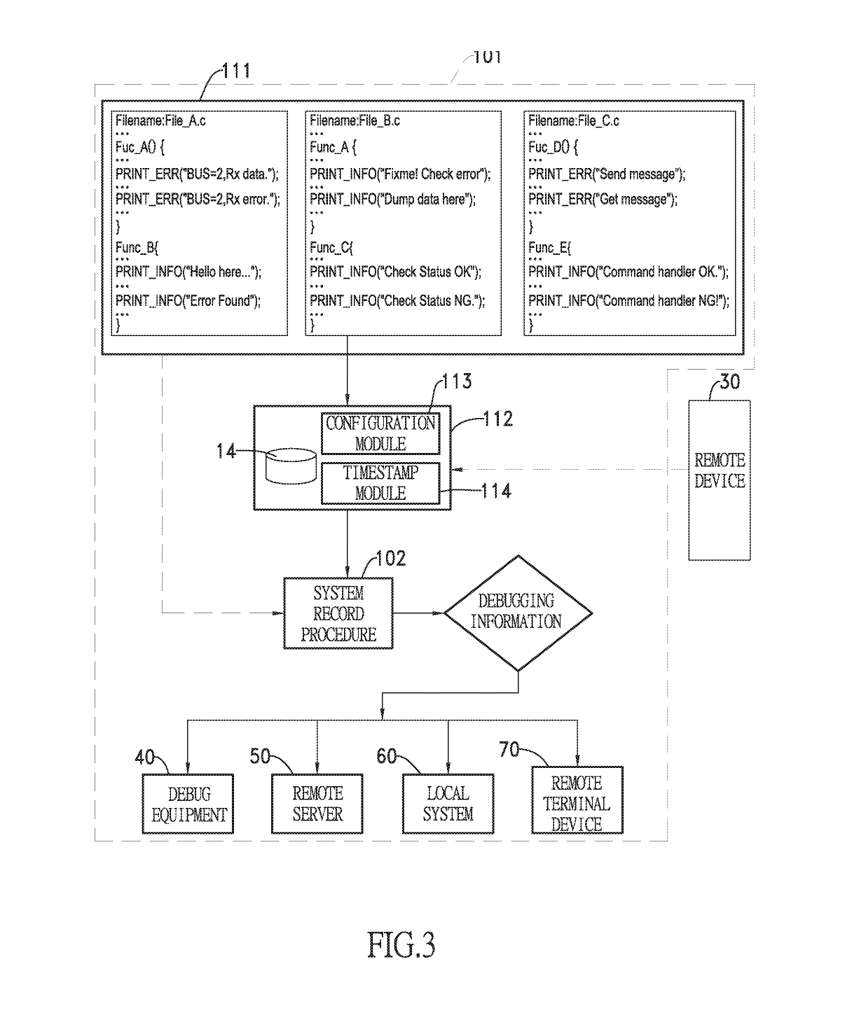

With reference to FIG. 3, the system log filter procedure 101 is implemented on the electronic device 10. The electronic device 10 executes the system log filter procedure 101 according to the command information input by the user. In the embodiment, the command information may comprise message level information. Further, the central processing unit 11 executes the program compile-time stage to establish an editable database 111. The editable database 111 comprises debugging information, and stores the debugging information into the memory unit 14.

In the embodiment, the debugging information of the editable database 111 comprises a plurality of file names, such as File_A.c, a plurality of function names, such as Fuc_A, wrong address information, and record tracing information corresponding to the function names, such as PRINT_ERR(“BUS-1, RX data”), etc.

The central processing unit 11 determines whether the program compile-time stage is executed according to a value of the command information. When the central processing unit 11 does not execute the program compile-time stage, the central processing unit 11 executes the system record procedure 102 according to the command information. When the central processing unit 11 executes the program compile-time stage, the central processing unit 11 further may execute an executing interface 112 when the central processing unit 11 executes the program runtime stage. The executing interface 112 comprises a configuration module 113 and a timestamp module 114. The central processing unit 11 receives the configured filtered information configured by the user through the configuration module 113. A user of the remote device 30 may use the remote device 30 to configure the configured filtered information and transmit the configured filtered information to the configuration module 113 that executes the executing interface 112 through the Internet.

The central processing unit 11 may compile the record tracing information of the debugging information to form timestamp information having a serial number through the timestamp module 114. The central processing unit 11 executes the system record procedure 102 of the operating system according to the configured filtered information, the debugging information corresponding to the configured filtered information, and the timestamp information corresponding to the configured filtered information. The system record procedure 102 determines content of the system log, and then the system record procedure 102 outputs the system log to an output equipment, such as a debug equipment 40, a remote server 50, a local system 60, and a remote terminal device 70.

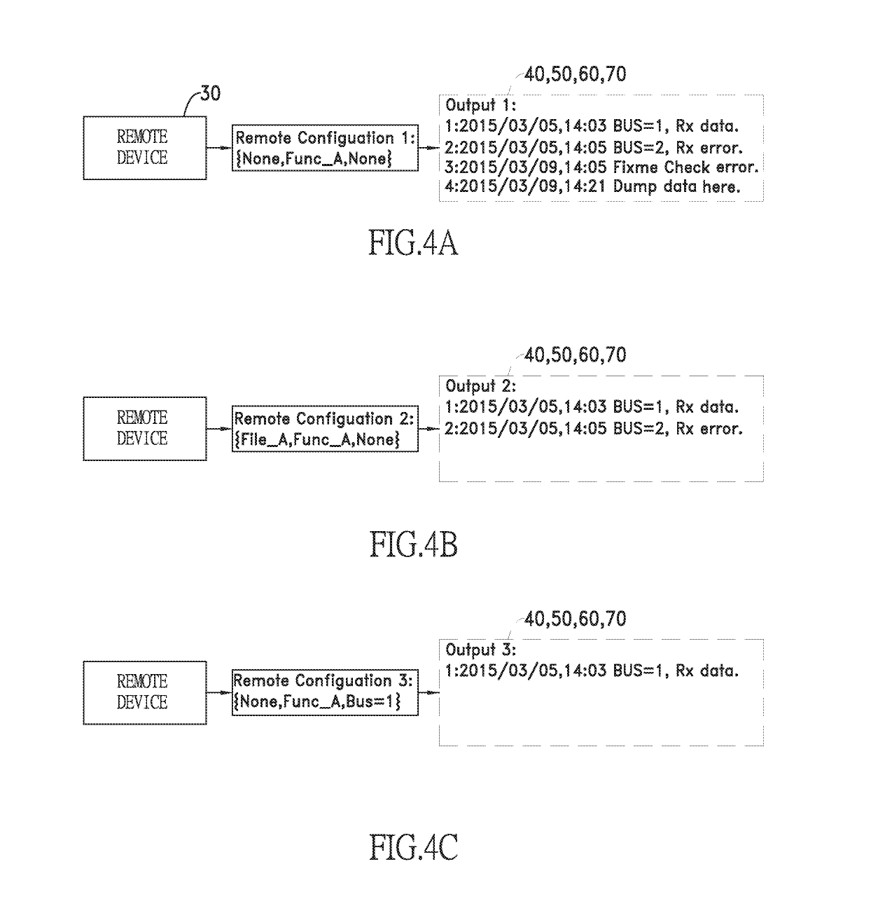

Further, with reference to FIGS. 4A, 4B, 4C, the user may use the remote device 30 to configure configured filtered information having debugging information. For example, the configured filtered information may comprise debugging information, such as:

Remote Configuration 1: {None, Func_A, None};

Remote Configuration 2: {File_A.c, Func_A, None};

Remote Configuration 3: {None, Func_A, BUS=1}.

The central processing unit 11 may execute the system record procedure 102 of the operating system to output a filtered system log, and output the filtered system log by the output equipment, such as a debug equipment 40, a remote server 50, a local system 60, and a remote terminal device 70. In the embodiment, the system log may comprise the configured filtered information and the debugging information, and the record tracing information of the debugging information may be compiled to form the timestamp information having the serial number.

With reference to FIG. 4A, when the configured filtered information of the remote device 30 comprises the debugging information, such as Remote Configuration 1: {None, Func_A, None}, the output equipment may output the system log of the timestamp information having the serial number. The system log may comprise the Output1, such as:

1: Mar. 5, 2015, 14:03, BUS=1, Rx data.

2: Mar. 5, 2015, 14:05, BUS=2, Rx error.

3: Mar. 5, 2015, 14:09, Fixme! Check error.

4: Mar. 5, 2015, 14:21, Dump data here.

With reference to FIG. 4B, when the configured filtered information of the remote device 30 comprises the debugging information, such as Remote Configuration 2: {File_A.c, Func_A, None}, the output equipment may output the system log of the timestamp information having the serial number. The system log may comprise the Output2, such as:

1: Mar. 5, 2015, 14:03, BUS=1, Rx data.

2: Mar. 5, 2015, 14:05, BUS=2, Rx error.

With reference to FIG. 4C, when the configured filtered information of the remote device 30 comprises the debugging information, such as Remote Configuration 3: {None, Func_A, BUS=1}, the output equipment may output the system log of the timestamp information having the serial number. The system log may comprise the Output3, such as:

1: Mar. 5, 2015, 14:03, BUS=1, Rx data.

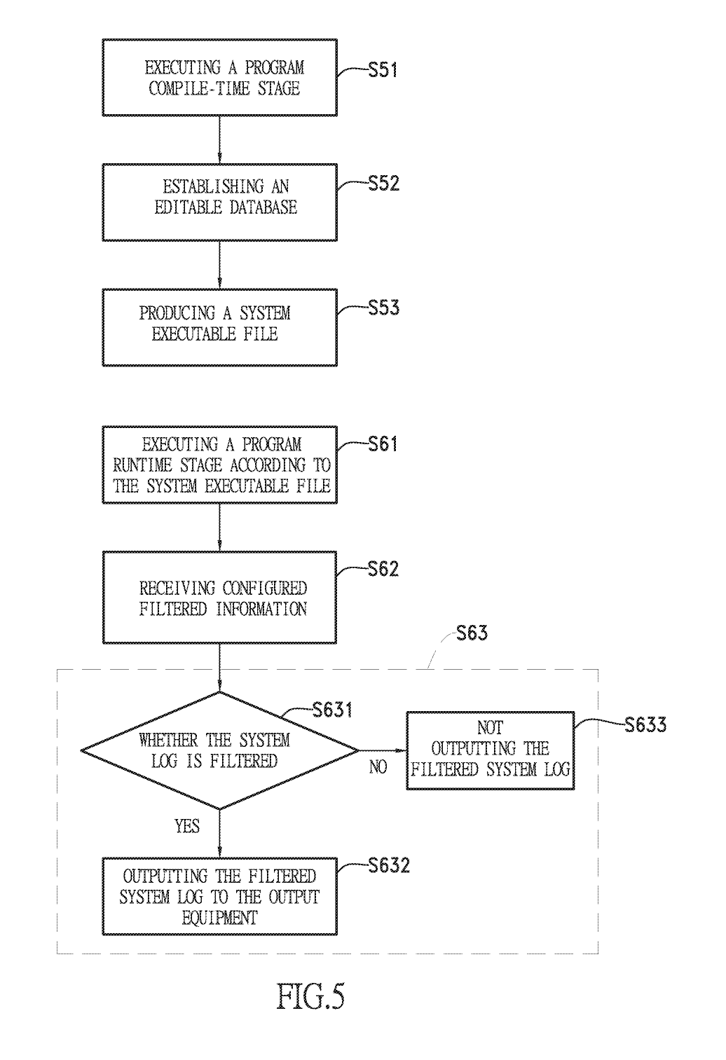

In addition, the method for filtering the system log under the operating system is implemented on the electronic device 10 installed with the operating system, and the electronic device 10 executes the system log filter procedure 101 according to a command information input by the user. With reference to FIG. 5, the method comprises the steps of:

executing a program compile-time stage (S51);

establishing an editable database 111 (S52), and producing a system executable file (S53); wherein the editable database 111 stores debugging information;

executing a program runtime stage according to the system executable file (S61) to receive configured filtered information (S62); wherein the configured filtered information may comprise a letter, a symbol, a string, a character, or any combination thereof, and the debugging information may comprise a plurality of file names, a plurality of function names, wrong address information, and record tracing information corresponding to the function names, etc; and

executing a system record procedure 102 of the operating system to output a filtered system log according to the debugging information stored in the editable database corresponding to the configured filtered information (S63).

The system log filter procedure 101 executes the program compile-time stage to produce the system executable file, and further executes the program runtime stage according to the system executable file. Then, the system record procedure 102 of the operating system filters the system log.

Further, the step of “executing a system record procedure 102 of the operating system to output a filtered system log according to the debugging information stored in the editable database corresponding to the configured filtered information (S63)” comprises the steps of:

determining whether the system log is filtered when the system record procedure 102 is executed according to the configured filtered information and the debugging information corresponding to the configured filtered information (S631) or whether the system log is filtered when the system record procedure 102 is executed according to the configured filtered information, the debugging information corresponding to the configured filtered information, and the command information corresponding to the configured filtered information; wherein the command information may comprise message level information;

when the system log is filtered, the filtered system log is outputted to the output equipment, such as a debug equipment 40, a remote server 50, a local system 60, and a remote terminal device 70 (S632); wherein the system log may comprise the configured filtered information and the debugging information, and the record tracing information of the debugging information may be compiled to form the timestamp information having the serial number;

when the system log is not filtered, the filtered system log is not outputted (S633).

In conclusion, the electronic device 10 may provide the input unit 12 to the user, such as an information tracer or a program designer, to input information, or may provide the transmitting unit 13 to receive information inputted by the user of the remote device 30. The central processing unit 11 executes the system log filter procedure 101 according to the command information inputted by the user.

The system log filter procedure 101 executes the program compile-time stage to store the debugging information stored in the editable database 111 edited by the user into the memory unit 14.

When the system log filter procedure 101 executes the program runtime stage, the central processing unit 11 receives the configured filtered information configured by the user. The central processing unit 11 immediately executes the system record procedure 102 of the operating system to output the filtered system log according to the debugging information stored in the memory unit 14 and corresponding to the configured filtered information. Then, the central processing unit 11 uses the output unit 15 to output the system log. The central processing unit 11 further uses the transmitting unit 13 to receive new configured filtered information configured by the user of the remote device 30, and outputs another system log filtered by the new configured filtered information. Therefore, the user may recognize and analyze the filtered system log, and the efficiency of tracing a specific system log may be raised.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for filtering a system log under an operating system, implemented on an electronic device installed with the operating system, and comprising steps of:
executing a program compile-time stage to establish an editable database, wherein the editable database stores debugging information; and
executing a program runtime stage to
receive configured filtered information; and
execute a system record procedure of the operating system to output a filtered system log according to the debugging information stored in the editable database corresponding to the configured filtered information.

2. The method as claimed in claim 1, wherein the step of executing the system record procedure of the operating system further comprises steps of:
determining whether the system log is filtered when the system record procedure is executed according to the configured filtered information and the debugging information corresponding to the configured filtered information; and
when the system log is filtered, outputting the filtered system log.

3. The method as claimed in claim 1, wherein:
the electronic device receives command information to execute the program compile-time stage;
the step of executing the system record procedure of the operating system further comprises steps of:
determining whether the system log is filtered when the system record procedure is executed according to the configured filtered information, the debugging information corresponding to the configured filtered information, and the command information corresponding to the configured filtered information; and
when the system log is filtered, outputting the filtered system log.

4. The method as claimed in claim 1, wherein:
the configured filtered information comprises a letter, a symbol, a string, a character, or any combination thereof:
the debugging information comprises a plurality of file names, a plurality of function names, wrong address information, and record tracing information corresponding to the function names;
the system log comprises the configured filtered information and the debugging information; and
the record tracing information of the debugging information is compiled to form timestamp information having a serial number.

5. The method as claimed in claim 1, wherein:
when the program compile-time stage is executed, a system executable file is produced;
the program runtime stage is executed on the electronic device according to the system executable file; and
the system log is outputted by the system record procedure of the operating system.

6. The method as claimed in claim 2, wherein:
when the program compile-time stage is executed, a system executable file is produced;
the program runtime stage is executed on the electronic device according to the system executable file; and
the system log is outputted by the system record procedure of the operating system.

7. The method as claimed in claim 3, wherein:
when the program compile-time stage is executed, a system executable file is produced;
the program runtime stage is executed on the electronic device according to the system executable file; and
the system log is outputted by the system record procedure of the operating system.

8. The method as claimed in claim 4, wherein:
when the program compile-time stage is executed, a system executable file is produced;
the program runtime stage is executed on the electronic device according to the system executable file; and
the system log is outputted by the system record procedure of the operating system.

9. A system for filtering a system log under an operating system, the system comprising an electronic device installed with the operating system, wherein the electronic device comprises:
an input unit, configured to receive information inputted by a user;
an output unit;
a transmitting unit, configured to receive information inputted by a remote user;
a memory unit; and
a central processing unit, configured to be electronically connected to the input unit, the output unit, the transmitting unit, and the memory unit;
wherein the central processing unit executes the method as claimed in claim 1.

10. The system as claimed in claim 9, further comprising:
a remote device, exchanging information with the electronic device through the Internet, and transmitting new configured filtered information configured by the user to the electronic device.

11. The system as claimed in claim 10, wherein the remote device comprises:
a configuration setting interface for the user to operate and to input information;
wherein the configuration setting interface comprises a webpage configuration page and a command information bar; and
wherein the configuration setting interface provides the webpage configuration page to the user to produce new configured filtered information, and provides the command information bar to the user to input new command information.

12. The system as claimed in claim 9, wherein:
the central processing unit comprises an executing interface;
the executing interface comprises a configuration module and a timestamp module;
the central processing unit receives the configured filtered information configured by the user through the configuration module;
the central processing unit compiles record tracing information of the debugging information to form timestamp information having a serial number through the timestamp module; and
the central processing unit executes a system record procedure of the operating system according to the configured filtered information and the debugging information corresponding to the configured filtered information to output the system log.

13. The system as claimed in claim 10, wherein:
the central processing unit comprises an executing interface;
the executing interface comprises a configuration module and a timestamp module;
the central processing unit receives the configured filtered information configured by the user through the configuration module;
the central processing unit compiles record tracing information of the debugging information to form timestamp information having a serial number through the timestamp module; and
the central processing unit executes a system record procedure of the operating system according to the configured filtered information and the debugging information corresponding to the configured filtered information to output the system log.

14. The system as claimed in claim 11, wherein:
the central processing unit comprises an executing interface;
the executing interface comprises a configuration module and a timestamp module;
the central processing unit receives the configured filtered information configured by the user through the configuration module;
the central processing unit compiles record tracing information of the debugging information to form timestamp information having a serial number through the timestamp module; and
the central processing unit executes a system record procedure of the operating system according to the configured filtered information and the debugging information corresponding to the configured filtered information to output the system log.

15. The system as claimed in claim 12, wherein:
the electronic device further outputs the system log to an output equipment;
the output equipment is a debug equipment, a remote server, a local system, or a remote terminal device.

16. The system as claimed in claim 13, wherein:
the electronic device further outputs the system log to an output equipment;
the output equipment is a debug equipment, a remote server, a local system, or a remote terminal device.

17. The system as claimed in claim 14, wherein:
the electronic device further outputs the system log to an output equipment;
the output equipment is a debug equipment, a remote server, a local system, or a remote terminal device.
